(19) United States
(12) Patent Application Publication
(10) Pub. No.: US 2014/0082584 A1
(43) Pub. Date: Mar. 20, 2014

(54) METHOD AND SYSTEM FOR DEVELOPMENT OF APPLICATION PROGRAM

(71) Applicant: Electronics and Telecommunications Research Institute, Daejeon (KR)

(72) Inventors: Sang Cheol KIM, Gyeongsan-si (KR); Seon Tae KIM, Daejeon (KR)

(21) Appl. No.: 13/910,726

(22) Filed: Jun. 5, 2013

(30) Foreign Application Priority Data
Sep. 18, 2012 (KR) 10-2012-0103199

(51) Int. Cl. G06F 9/44; G06F 11/36

(52) U.S. Cl. CPC G06F 8/20; G06F 11/3668
USPC 717/104; 717/124; 717/126

(57) ABSTRACT

Provided is a method and system for developing an application program efficiently. The method may include modeling an application program based on a development goal of the application program, and decomposing the modeled application program into sub-application programs, and modeling the sub-application programs.

### CROSS-REFERENCE TO RELATED APPLICATION

This application claims the priority benefit of Korean Patent Application No. 10-2012-0103199, filed on Sep. 18, 2012, in the Korean Intellectual Property Office, the disclosure of which is incorporated herein by reference.

### BACKGROUND

1. Field of the Invention

The following description relates to a method and system for development of an application program, and more particularly, to a method and system for designing and modeling a large application program for efficient development of the large application program.

2. Description of the Related Art

Developing a large embedded application program on a real time operating system (RTOS), in particular, as a whole, is difficult due to a large scale. An alternative development strategy operates through decomposing a large application program into smaller application programs based on unique functions, and developing and integrating the smaller application programs. This decomposition paradigm is based on breaking down a large application program into smaller application programs based on unique functions constituting the application program.

However, in this case, an error may occur between the smaller application programs during integration of the smaller application programs based on methods used in developing the smaller application programs.

Accordingly, there is a need for an efficient development model for developing a large embedded application program on an RTOS.

### SUMMARY

An aspect of the present invention provides a method and system for developing an application program that may model a large application program based on a development goal of the large application program and may decompose the large application program into a plurality of sub-application programs.

Another aspect of the present invention also provides a method and system for developing an application program that may model the sub-application programs based on functions of the sub-application programs to reduce costs and time expended in developing the sub-application programs.

Still another aspect of the present invention also provides a method and system for developing an application program that may implement and test the modeled sub-application programs to integrate the sub-application programs rapidly with the minimized likelihood of an error occurring between the sub-application programs.

Yet another aspect of the present invention also provides a method and system for developing an application program that may approach the large application program more efficiently using a structured development model proposed below.

According to an aspect of the present invention, there is provided a method of developing an application program, the method including modeling an application program based on a development goal of the application program, and decomposing the modeled application program into sub-application programs, and modeling the sub-application programs.

The modeling of the application program may include modeling the application program using a set of the sub-application programs decomposed based on the development goal of the application program.

The modeling of the application program may include modeling the application program using dependencies of a function for calling a sub-application program and a function for passing a control to a sub-application program at a termination time of a different sub-application program.

The modeling of the application program may include modeling the application program using a linking program including a shared code for linking the sub-application programs.

The linking program may model the application program using a callback function distributor to call the sub-application programs in response to a callback function being invoked.

The modeling of the sub-application programs may include modeling the sub-application programs using a common interface for identifying the sub-application programs.

The common interface may change the control using unique designated numbers of the sub-application programs when a change in the control over the sub-application programs occurs.

The common interface may initialize a memory using an initialization function in which functions associated with initial memory allocation are registered.

The common interface may execute a sub-application program using a start function called to start the sub-application program.

The common interface may switch the control between different sub-application programs using a terminate function called to terminate a sub-application program.

The common interface may call different sub-application programs using a callback function used as a service routine for the sub-application programs.

The modeling of the sub-application programs may include modeling the sub-application programs using a set of threads used in the sub-application programs.

The modeling of the sub-application programs may include modeling the sub-application programs using a function calling relationship between functions included in the common interface and the threads.

The modeling of the sub-application programs may include modeling the sub-application programs using a crossbar model method in which a section, represented by a node, where the function calling relationship between the functions included in the common interface and the threads is valid.

According to another aspect of the present invention, there is provided a method of developing an application program, the method including implementing sub-application programs based on unique functions executable in the sub-application programs and testing the sub-application programs, and integrating the tested sub-application programs into an integrated application program and testing the integrated application program.

The implementing of the sub-application programs may include implementing the sub-application programs using a user application programming interface (API).

The testing of the integrated sub-application programs may include testing the integrated sub-application program by integrating initialization functions included in the tested sub-application programs.

The testing of the integrated application program may include verifying whether the tested sub-application program is called in response to a call being invoked by a callback function distributor included in the integrated sub-application program.

According to still another aspect of the present invention, there is provided a method of developing an application program, the method including modeling an application program based on a development goal of the application program, decomposing the modeled application program into sub-application programs and modeling the sub-application programs, implementing the sub-application programs based on goals of the sub-application programs and testing the sub-application programs, and integrating the tested sub-application programs into an integrated sub-application program and testing the integrated sub-application program.

According to yet another aspect of the present invention, there is provided a system for developing an application program, the system including a program modeling unit to model an application program based on a goal of the application program, a sub-program modeling unit to decompose the modeled application program into sub-application programs and model the sub-application programs, a testing unit to implement the sub-application programs based on goals of the sub-application programs and test the implemented sub-application programs, and an integrated testing unit to integrate the tested sub-application programs into an integrated sub-application program and test the integrated sub-application program.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating development of a large application program according to an exemplary embodiment;

FIG. 2 is a flowchart illustrating development of a large application program according to an exemplary embodiment;

FIG. 3 is a flowchart illustrating development of a large application program according to another exemplary embodiment;

FIG. 4 is a flowchart illustrating development of a large application program according to still another exemplary embodiment;

FIG. 5 is a diagram illustrating modeling of a large application program according to an exemplary embodiment;

FIG. 6 is a diagram illustrating modeling of a sub-application program according to an exemplary embodiment;

FIG. 7 is a diagram illustrating integration of sub-application programs according to an exemplary embodiment;

FIG. 8 is a diagram illustrating a data structure of a common interface of a sub-application program according to an exemplary embodiment; and

FIG. 9 is a diagram illustrating a data structure of a callback function distributor (CFD) of a large application program according to an exemplary embodiment.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

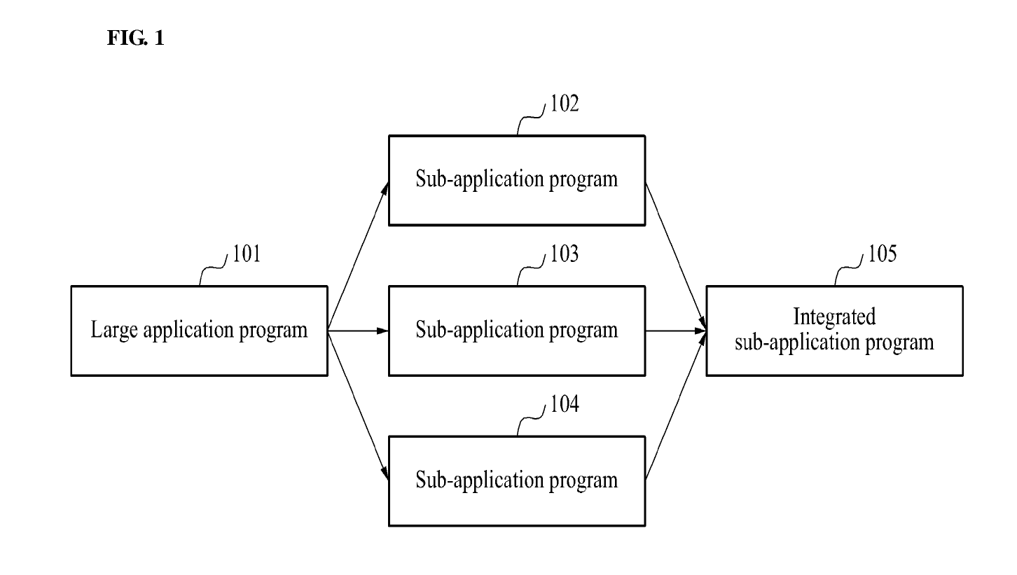

FIG. 1 is a diagram illustrating development of a large application program according to an exemplary embodiment.

Referring to FIG. 1, development of a large application program 101 may include decomposing the large application program 101 into a plurality of sub-application programs, developing the sub-application programs, and integrating the sub-application programs.

The large application program 101 may be modeled based on a program development goal. Here, the large application program 101 may correspond to an application program that may be developed through being decomposed into independent sub-application programs. Also, the large application program 101 may correspond to a large embedded application program on a real time operating system (RTOS). The modeling of the large application program 101 may correspond to representation of the large application program 101 in an organized structure to develop the large application program 101 efficiently. After modeling, the large application program 101 may be decomposed into a plurality of sub-application programs 102, 103, and 104 based on the program development goal.

For example, when the large application program 101 corresponds to a calculator program for executing operations such as, for example, addition, subtraction, division, and the like, the large application program 101 may be modeled in an organized structure based on a program development goal, and may be decomposed into sub-application programs corresponding to each function.

Each of the sub-application programs 102, 103, and 104 may have a unique function executable in the sub-application programs 102, 103, and 104. The sub-application programs 102, 103, and 104 may be written in a source code to perform the unique functions. The sub-application programs 102, 103, and 104 may be modeled using various methods based on the unique functions. Based on the methods used in modeling the sub-application programs 102, 103, and 104, an error occurring during integrating of the sub-application programs 102, 103, and 104 may be minimized and the time required for integrating the sub-application programs 102, 103, and 104 may be reduced.

For the sub-application programs 102, 103, and 104, testing may be conducted as to whether the unique functions are implemented correctly. A goal of the testing may be to reduce an error that may occur during integrating the sub-application programs 102, 103, and 104, and eliminate a need for unnecessary modifications of the sub-application programs 102, 103, and 104.

Subsequent to the testing, the sub-application programs 102, 103, and 104 may be combined into one integrated sub-application program 105. In this instance, the integrated sub-application program 105 may include a callback function distributor (CFD) to distribute and call the corresponding sub-application programs 102, 103, and 104 in response to a callback function being invoked. Also, the integrated sub-application program 105 may test whether the callback function included in the sub-application programs 102, 103, and 104 is invoked correctly. For example, whether an error occurs in a program flow across the sub-application programs 102, 103, and 104 may be verified.

As another example, whether the integrated sub-application program 105 is identical to the initial large application program 101 may be verified.

A development model of the large application program 101 may allow an efficient approach to the large application program 101 for development of the large application program 101. Here, the development model may contribute to reduction of a development time of the large application program 101 by integrating the sub-application programs 102, 103, and 104 in a simple manner of calling initialization functions of the sub-application programs 102, 103, and 104 implemented based on the unique functions of the sub-application programs 102, 103, and 104.

In particular, the development model may be found to be more efficient for a collaborative team project.

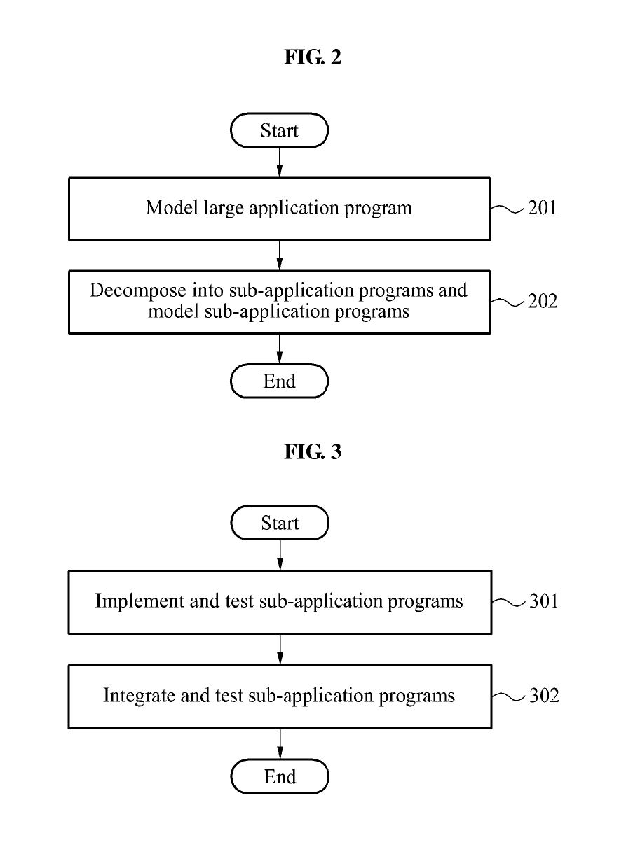

FIG. 2 is a flowchart illustrating development of a large application program according to an exemplary embodiment.

Referring to FIG. 2, in operation 201, also referred to as a first development stage, a large application program may be modeled based on a development goal of the large application program. In the first development stage, the large application program may be modeled using a set of sub-application programs consisting of the large application program, a set of dependencies among the sub-application programs, and a linking program linking the sub-application programs.

In the first development stage, the large application program may be modeled using a set of multiple sub-application programs, each sub-application program being capable of performing a unique function. For example, the set of sub-application programs may include sub-application programs performing unique functions such as, for example, addition, subtraction, division, and multiplication.

In the first development stage, the large application program may be modeled by assigning dependencies based on whether dependencies exist among the sub-application programs. For example, the sub-application programs may be included in the set of sub-application programs, and the large application program may be modeled by assigning dependencies to different sub-application programs using a start function and a terminate function. In this example, the start function may correspond to a function for calling a sub-application program, and the terminate function may correspond to a function for returning a control to a calling sub-application program at a termination time of a called sub-application program.

As another example, in the first development stage, the large application program may be modeled using the linking program linking the sub-application programs. In this example, the linking program may correspond to a shared code for linking the sub-application programs. Here, the linking program may include a main function and a CFD. For example, different sub-application programs may be linked by the CFD invoking a callback function included in the main function.

In operation 202, also referred to as a second development stage, the modeled large application program may be decomposed into a plurality of sub-application programs and the sub-application programs may be modeled. More particularly, in the second development stage, the large application program modeled in the first development stage may be decomposed into the sub-application programs. Also, the sub-application programs may be modeled.

In this instance, before modeling the sub-application programs, a common interface for identifying the sub-application programs may be modeled. The common interface may be modeled using a unique designated number of the sub-application program, an initialization function, a start function, a terminate function, and a callback function for the sub-application program.

The unique designated number of the sub-application program may correspond to a common interface for identifying the sub-application programs. For example, when a change in a control over a sub-application program occurs, a sub-application program having the control may identify a unique designated number and may pass the control to a sub-application program corresponding to the identified unique designated number. In this instance, the unique designated number may correspond to a constant.

The initialization function may correspond to a common interface in which functions associated with initial memory allocation of the sub-application program may be registered. For example, the initialization function may correspond to a function in which functions associated with initial memory allocation, for example, thread creation, may be registered after operating system (OS) initialization is completed.

The start function may correspond to a common interface that may be called to execute the sub-application program. For example, the start function may include various functions needed to start execution of the sub-application program.

The terminate function may correspond to a common interface that may be called to terminate the sub-application program. For example, the terminate function may correspond to a function that may be called to switch a control from one sub-application program to another. The terminate function may terminate all threads being run for the sub-application program. The callback function may be available after the callback function is registered by the sub-application program. For example, the callback function may be used in lieu of an interrupt service routine, and may be used for serving the sub-application program.

Here, the initialization function, the start function, and the terminate function may correspond to interface functions for each sub-application program. The callback function may correspond to a set of callback functions.

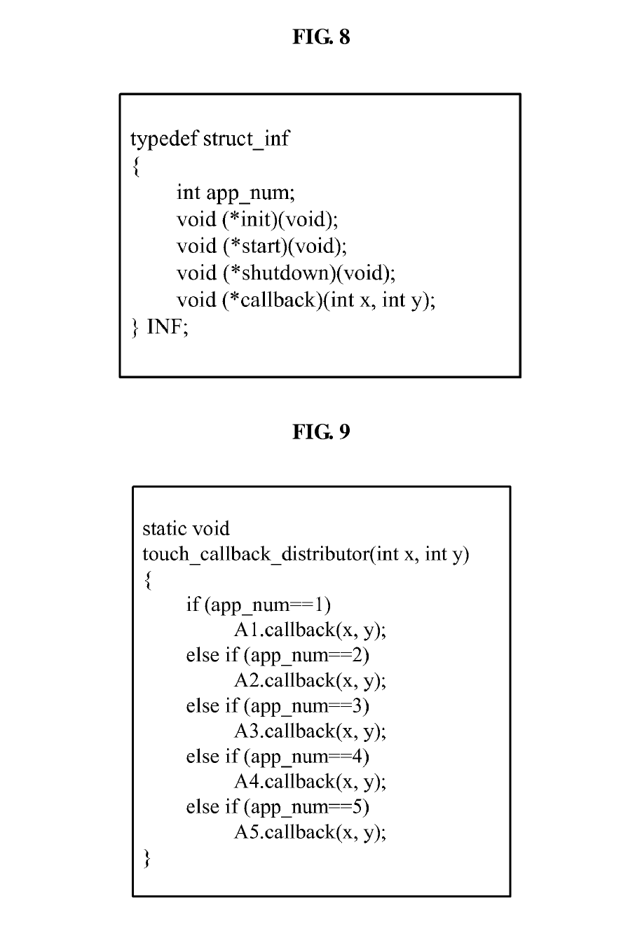

The modeled common interface may be used to describe the sub-application program. For example, the common interface may be specified within the sub-application program in a form of INF app_inf={1, init, start, shutdown, callback}. In this example, the common interface may be defined in a general purpose programming language, such as C, and may be specified within the sub-application program, as shown in FIG. 8.

In the second development stage, the sub-application program may be modeled using a set of threads used in the sub-application program. In this instance, the sub-application program may correspond to a thread-driven program, and in some cases, the sub-application program may not correspond to a thread-driven program. When the sub-application program does not correspond to a thread-driven program, a set of threads may correspond to an empty set (φ).

In another example, in the second development stage, the sub-application program may be modeled using a set of mapping relationships between functions included in the common interface and threads. In detail, the sub-application program may be modeled using function calling relationships between the functions included in the common interface and the threads.

According to an exemplary embodiment, the large application program may be modeled based on a development goal of the large application program, and decomposed into sub-application programs that may be modeled based on unique functions of the sub-application programs, thereby developing the large application program more efficiently.

FIG. 3 is a flowchart illustrating development of a large application program according to another exemplary embodiment.

Referring to FIG. 3, in operation 301, also referred to as a third development stage, unique functions executable in the modeled sub-application programs may be implemented and tested.

In the third development stage, the sub-application programs may be implemented based on the unique functions executable in the sub-application programs. For example, a sub-application program for an addition function may be implemented to carry out the unique function through various methods such as, for example, use of a subtractor.

Also, in the third development stage, the unique function may be implemented by specifying the sub-application program using the common interface. Also, in the third development stage, the sub-application program may be implemented using an implementation program for implementing a sub-application program. Also, the implementation program may correspond to a user application program interface (API) of a particular RTOS. For example, the sub-application program may be implemented using the API of the particular RTOS. Also, the API of the particular RTOS may include various APIs, for example, thread_creater( ) for thread creation, thread_exit( ) for thread exit, thread_terminate( ) for thread termination, and the like.

Also, in the third development stage, operation of the unique functions of the sub-application programs may be tested using the main functions included in the sub-application programs. In this instance, in the third development stage, the test may be conducted as many times as possible to prevent an error to the maximum. This may be to minimize modification of the sub-application programs during integrating the sub-application programs.

In operation 302, also referred to as a fourth development stage, the tested sub-application programs may be integrated into one. In the fourth development stage, the tested sub-application programs may be combined into one integrated sub-application program. In this instance, the tested sub-application programs may be integrated into one integrated sub-application program by integrating the initialization functions included in the main functions of the tested sub-application programs. The integrated sub-application program may include a CFD to invoke the callback functions registered in the sub-application programs. In the fourth development stage, testing may be conducted as to whether the CFD invokes a callback function included in the integrated sub-application program correctly.

A developer may verify whether the integrated sub-application program is identical to the initial large application program by comparing the integrated sub-application program to the modeled large application program.

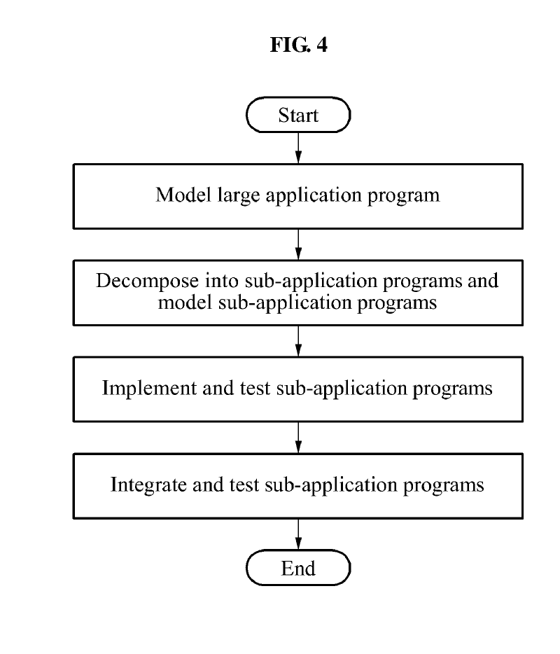

In addition, the large application program may be developed using a combination of the embodiment of FIG. 2 and the embodiment of FIG. 3. Such an embodiment is illustrated in FIG. 4. For example, the large application program may be developed by performing operations of FIG. 4 in order.

Although not shown in FIGS. 2, through 4, the large application program may be developed by an application program development system intended for a large application program. The application program development system may include a program modeling unit, a sub-program modeling unit, a testing unit, and an integrated testing unit. In this instance, the program modeling unit may correspond to operation 201 of FIG. 2. The sub-program modeling unit may correspond to operation 202 of FIG. 2. The testing unit may correspond to operation 301 of FIG. 3. The integrated testing unit may correspond to operation 302 of FIG. 3.

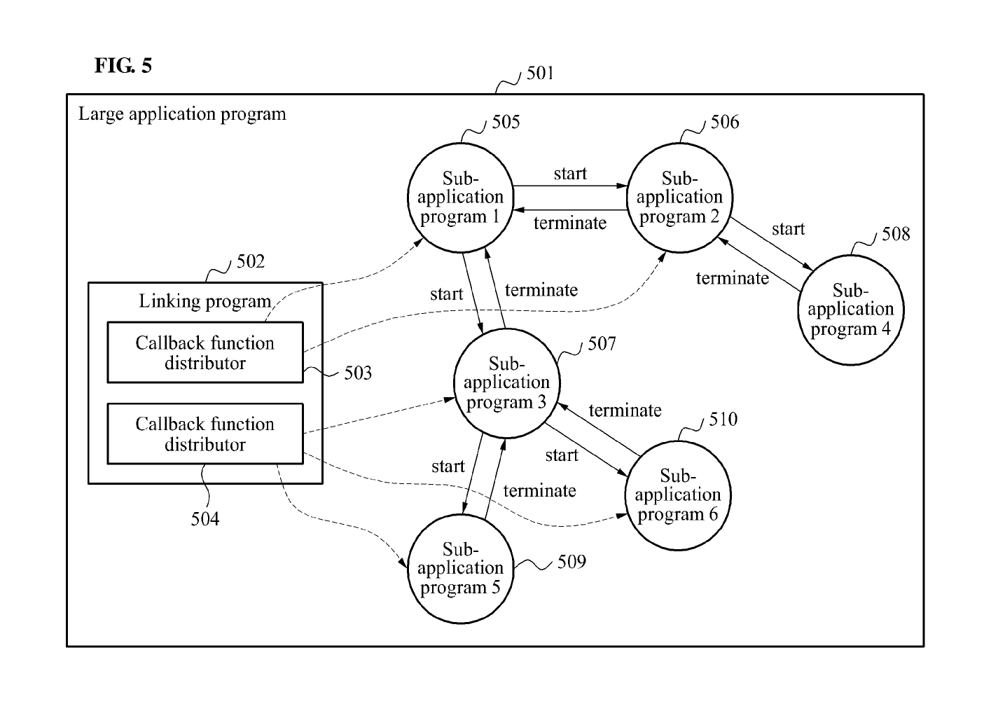

FIG. 5 is a diagram illustrating modeling of a large application program according to an exemplary embodiment.

Referring to FIG. 5, a large application program 501 may be modeled using a set of sub-application programs 505, 506, 507, 508, 509, and 510, dependencies among the sub-application programs 505, 506, 507, 508, 509, and 510, and a linking program 502.

The linking program 502 may include a main function and a CFD. The linking program 502 may correspond to a shared code for the sub-application programs 505, 506, 507, 508, 509, and 510.

The linking program 502 may include at least one CFD, for example, CFDs 503 and 504, based on calling types of the sub-application programs 505, 506, 507, 508, 509, and 510, within the large application program 501. For example, the CFD 503 may call the sub-application programs 505 and 506 based on a calling type. Also, the CFD 504 may call the sub-application programs 507, 509, and 510 based on a calling type other than the calling type used by the CFD 503. In this instance, the sub-application programs 505 and 506 may include callback functions of the same calling type. Accordingly, the sub-application programs 505 and 506 may be called through the CFD 503.

Also, the CFDs 503 and 504 may call all of the sub-application programs 505, 506, 507, 508, 509, and 510 consisting of the large application program 501 by distributing callback functions included in the set of sub-application programs 505, 506, 507, 508, 509, and 510. In this instance, a number of callbacks of the CFDs may be defined to be a total number of callback functions included in the set of sub-application programs 505, 506, 507, 508, 509, and 510.

For example, callbacks corresponding to the number of callback functions of the sub-application programs 505, 506, 507, 508, 509, and 510 may be defined in the CFDs 503 and 504, as shown in FIG. 9.

Also, the sub-application programs 505, 506, 507, 508, 509, and 510 may have two types of dependencies, “start” and “terminate”. For example, “start” may be used when the sub-application program 505 having a control calls the different sub-application program 506. Also, “terminate” may be used to terminate the sub-application program 506 and to pass the control back to the calling sub-application program 505. In this instance, “terminate” may terminate all threads being run for the sub-application program 506.

The “start” and “terminate” may represent a level of dependency in the relationship between sub-application programs.

For example, the sub-application program 506 called with a start dependency may call the sub-application program 508 with a start dependency of the sub-application program 508 occurring while the sub-application program 506 is being run. Also, after the called sub-application program 508 is executed in a program flow of the sub-application program 508, the sub-application program 508 may give back a control to the sub-application program 506 with a terminate dependency.

Here, the start and terminate dependencies may be assigned to different sub-application programs multiple number of times. For example, the start and terminate dependencies may be assigned to different sub-application programs continuously based on correlation between the sub-application programs in the process of executing the sub-application programs. Accordingly, the start and terminate dependencies may link the individual sub-application programs.

Based on functions of the sub-application programs, there may be a lack of dependency between the sub-application programs. For example, dependencies may exist between the sub-application program 507 and the different sub-application programs 509 and 510, and there may be a lack of dependency between the sub-application program 509 and the different sub-application program 510. In this instance, the start and terminate dependencies may be determined based on correlation between the sub-application programs.

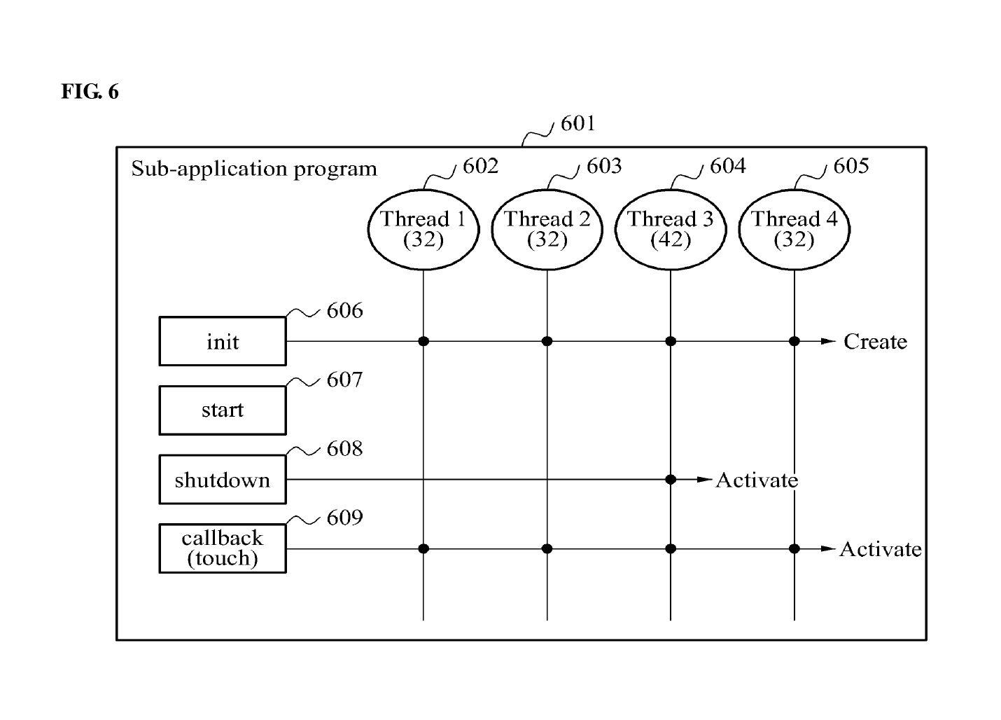

FIG. 6 is a diagram illustrating modeling of a sub-application program according to an exemplary embodiment.

Referring to FIG. 6, a sub-application program 601 may be modeled using call calling relationships between functions 606, 607, 608, and 609 of a common interface and threads 602, 603, 604, and 605 included in the sub-application program 601.

The call calling relationships between the functions 606, 607, 608, and 609 and the threads 602, 603, 604, and 605 may be represented using a crossbar model in a form of a crossbar. In this instance, a number in parentheses may indicate a priority for each of the threads 602, 603, 604, and 605. The crossbar model may represent the relationships by connecting the functions 606, 607, 608, and 609 to the threads 602, 603, 604, and 605 with intersecting lines. Also, the crossbar model may represent the function calling relationships by indicating the functions 606, 607, 608, and 609 in arrows, with a node placed at a section where the function calling relationship is valid. For example, the init( ) function 606 may create four threads. Also, the shutdown( ) function 608 may be activated from the third thread 604.

Here, the crossbar model may represent the calling relationships about the functions 606, 607, 608, and 609 used to create the threads 602, 603, 604, and 605 and the threads 602, 603, 604, and 605 used to generate or activate the functions 606, 607, 608, and 609 within the sub-application program 601.

A simple representation of the function calling relationship may be provided by indicating where a thread is created or a function is activated, so that complexity in representing the function calling relationship may be reduced. This form of representation may be very useful in understanding the function calling relationship. Further, this form of representing the function calling relationship may allow a developer to grasp the function calling relationship at a glance.

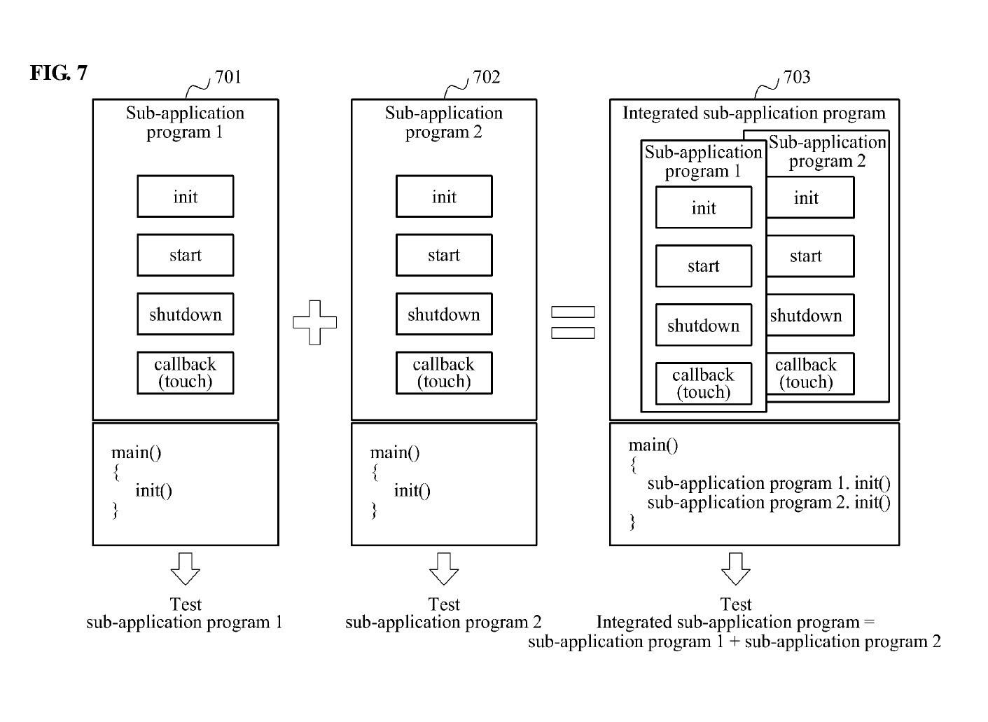

FIG. 7 is a diagram illustrating integration of sub-application programs according to an exemplary embodiment.

Referring to FIG. 7, an integrated sub-application program 703 may include a first sub-application program 701 and a second sub-application program 702. The first sub-application program 701 and the second sub-application program 702 may be combined into the integrated sub-application program 703 in a simple manner. The first sub-application program 701 and the second sub-application program 702 may be combined into the integrated sub-application program 703 by integrating initialization functions included in main functions of the first sub-application program 701 and the second sub-application program 702.

The first sub-application program 701 and the second sub-application program 702 may be combined into the integrated sub-application program 701, absent special modifications. The combination may result from a test conducted sufficiently for preventing an error in the implementation of the independent sub-application programs 701 and 702.

The integrated sub-application program 703 may implement a CFD to test whether a corresponding callback function is invoked to call the first sub-application program 701 and the second sub-application program 702 correctly.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard discs, floppy discs, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

According to the exemplary embodiments, a large application program may be modeled based on a development goal of the large application program, and may be decomposed into a plurality of sub-application programs.

According to the exemplary embodiments, the sub-application programs may be modeled based on functions of the sub-application programs to reduce costs and time expended in developing the sub-application programs.

According to the exemplary embodiments, the modeled sub-application programs may be implemented and tested to enable rapid integration of the sub-application programs with the minimized likelihood of an error occurring between the sub-application programs.

According to the exemplary embodiments, an efficient approach to the large application program may be provided using a structured development model proposed in the present disclosure.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of developing an application program, the method comprising:
modeling an application program based on a development goal of the application program; and
decomposing the modeled application program into sub-application programs, and modeling the sub-application programs.

2. The method of claim 1, wherein the modeling of the application program comprises modeling the application program using a set of the sub-application programs decomposed based on the development goal of the application program.

3. The method of claim 1, wherein the modeling of the application program comprises modeling the application program using dependencies of a function for calling a sub-application program and a function for passing a control to a sub-application program at a termination time of a different sub-application program.

4. The method of claim 1, wherein the modeling of the application program comprises modeling the application program using a linking program including a shared code for linking the sub-application programs.

5. The method of claim 4, wherein the linking program models the application program using a callback function distributor to call the sub-application programs in response to a callback function being invoked.

6. The method of claim 1, wherein the modeling of the sub-application programs comprises modeling the sub-application programs using a common interface for identifying the sub-application programs.

7. The method of claim 6, wherein the common interface changes the control using unique designated numbers of the sub-application programs when a change in the control over the sub-application programs occurs.

8. The method of claim 6, wherein the common interface initializes a memory using an initialization function in which functions associated with initial memory allocation are registered.

9. The method of claim 6, wherein the common interface executes a sub-application program using a start function called to start the sub-application program.

10. The method of claim 6, wherein the common interface switches the control between different sub-application programs using a terminate function called to terminate a sub-application program.

11. The method of claim 6, wherein the common interface calls different sub-application programs using a callback function used as a service routine for the sub-application programs.

12. The method of claim 1, wherein the modeling of the sub-application programs comprises modeling the sub-application programs using a set of threads used in the sub-application programs.

13. The method of claim 12, wherein the modeling of the sub-application programs comprises modeling the sub-application programs using a function calling relationship between functions included in the common interface and the threads.

14. The method of claim 13, wherein the modeling of the sub-application programs comprises modeling the sub-application programs using a crossbar model method in which a section, represented by a node, where the function calling relationship between the functions included in the common interface and the threads is valid.

15. A method of developing an application program, the method comprising:
implementing sub-application programs based on unique functions executable in the sub-application programs, and testing the sub-application programs; and
integrating the tested sub-application programs into an integrated application program, and testing the integrated application program.

16. The method of claim 15, wherein the implementing of the sub-application programs comprises implementing the sub-application programs using a user application programming interface (API).

17. The method of claim 15, wherein the testing of the integrated sub-application programs comprises testing the integrated sub-application program by integrating initialization functions included in the tested sub-application programs.

18. The method of claim 15, wherein the testing of the integrated application program comprises verifying whether the tested sub-application program is called in response to a call being invoked by a callback function distributor included in the integrated sub-application program.

19. A method of developing an application program, the method comprising:
modeling an application program based on a development goal of the application program;
decomposing the modeled application program into sub-application programs, and modeling the sub-application programs;
implementing the sub-application programs based on goals of the sub-application programs, and testing the sub-application programs; and
integrating the tested sub-application programs into an integrated sub-application program, and testing the integrated sub-application program.

20. A system for developing an application program, the system comprising:
a program modeling unit to model an application program based on a goal of the application program;
a sub-program modeling unit to decompose the modeled application program into sub-application programs and to model the sub-application programs;
a testing unit to implement the sub-application programs based on goals of the sub-application programs and to test the implemented sub-application programs; and
an integrated testing unit to integrate the tested sub-application programs into an integrated sub-application program and to test the integrated sub-application program.
